(19) United States
(12) Patent Application Publication
(10) Pub. No.: US 2003/0120594 A1
(43) Pub. Date: Jun. 26, 2003

(54) Method, system and data structure for an improved billing protocol

(75) Inventors: George S. Shaginaw, Reston, VA (US); Jeffrey W. Edgerton, Sterling, VA (US); Mary Patterson Clark, Crofton, MD (US); Parry L. Snow, Alexandria, VA (US); L. Kyle Spinks, Alexandria, VA (US); Gepsie Cox, Columbia, MD (US)

Correspondence Address: Squire, Sanders & Dempsey L.L.P., Two Renaissance Square, Suite 2700, 40 North Central Avenue, Phoenix, AZ, 85004-4498, US

(73) Assignee: Cibernet, Inc.

(21) Appl. No.: 10/006,167

(22) Filed: Dec. 4, 2001

(51) Int. Cl. G06F 17/60

(52) U.S. Cl. 705/40

(57) ABSTRACT

A data structure for exchanging billing information is provided. The data structure comprises a transmission information section and at least one record section containing billing information on one or more events. The record section includes a rate element for defining a chargeable unit.

### TECHNICAL FIELD OF THE INVENTION

This invention relates in general to billing reconciliation in wireless communication systems and more specifically to a method, system and data structure for an improved billing protocol.

### BACKGROUND OF THE INVENTION

Cellular phones and similar wireless communication devices are increasingly becoming a part of everyday life. As the cellular market matures, different uses for cellular phones are developed. For example, many cellular phones today are “web-enabled” which allows for the user of the cellular phone to access, typically for a fee, the Internet. Some cellular phones also have the capability, again for a fee, to exchange short text messages or to send instant messages to communicate with others using text instead of voice communication. Cellular phone users may also now, and, to a greater extent, in the future, purchase goods and services from a variety of vendors using the user's cellular phone. These services are typically provided by service providers different than the provider of phone service. A system must then exist such that the service providers can be paid.

An example of a communication network is illustrated in FIG. 1. Network 100 includes a plurality of subscribers represented by user 102 who is using a cellular phone 104. User 102 has a contract or similar agreement with a home network operator 106. Home network operator 106 is the entity that bills user 102 for cost incurred in the use of the cellular phone 104. That is, home network operator 106 is the cellular provider and billing entity for the user 102. Examples of cellular providers include AT&T Wireless Services, and Sprint PCS. Typically, a user 102 has a home area where phone calls cost a certain amount. Outside that area, the user 102 is in a roaming area where a different provider provides service. The roaming providers charge a fee for users to access the roaming providers network. when user 102 places or receives a call in an area not supported by the home network operator 106, the user 102 is said to be roaming in a visited network operator's 108 network. The visited network operator 108 tracks usage by the roaming user and sends billing information back to the home network operator 106. Home network operator 106 then needs to pay the visited network operator 108 for its user's 102 usage. Home network operator 106 will also need to bill user 102 for the usage.

Additionally, in modern networks, user 102 can access other services provided by content and service provider 110 such as Internet access or short messaging services (SMS). The content and service provider 110 needs to present a bill back to the home network operator 106 in order to get paid. Then home network operator 106 can bill the user 102. Generically, both content and service provider 110 and visited network operator 108 may be referred to as service providers. Of course, home network operator 106 can also operate as a visited network operator to users that are roaming in the home network operator's 106 network. In order to facilitate billing between providers a method is needed for the accurate billing of services between parties.

One such method is the Transferred Account Procedure (TAP), which is maintained by the GSM association. TAP allows visited network operators to, among other things, bill home network operators for roaming charges. While TAP is a useful system, it is limited because TAP is limited to wireless services only. Additionally, TAP also does not include record identifiers and unique file identifiers.

Another system is the Cellular Intercarrier Billing Exchange Roamer (CIBER) System operated by CIBERNET, Corp. of Washington DC. In this system CIBER records are exchanged to facilitate the billing of roaming charges. However, CIBER records are designed to support wireless services, primarily wireless roaming. Also, CIBER works in a batch-processing mode only and is unable to support the exchange of a single record. Additionally, CIBER records must have end user identification.

What is needed is a record that overcomes the drawbacks of the current systems.

### SUMMARY OF THE INVENTION

It is an object of the present invention to overcome at least one of the foregoing problems by providing a method, system and data structure for an improved billing protocol.

In one embodiment, a data structure for exchanging billing information between a first party and a second party is provide. The billing structure includes a transmission information section. The billing structure also includes a record section containing billing information on one or more events. The record section including a rate element for defining a chargeable unit.

In another embodiment, a method for processing billing information between a service provider and a bill processing entity is provided. In a first step a data structure is generated at the service provider, the data structure including an identification field and one or more billing records. The data structure is sent to the bill processing entity. At the bill processing entity the identification field of the data structure and the format of the data structure are verified. The data structure is returned to the service provider if the verifying fails. The billing records of the data structures that pass the verification process are processed.

In another embodiment, a system for processing billing information is provided. The system includes a billing computer operable to generate a billing data structure having at least one billing record for at least one billing event. The billing data structure includes a rate element attribute that defines a chargeable unit. The system also includes a bill processing computer coupled to the billing computer. The bill processing computer includes a verification engine operable to perform a validation process on the billing data structure, a return engine operable to process the billing data structure which fail the verification process and a process engine coupled to the verification engine to process the billing records that pass the verification process.

In another embodiment, a settlement method between a first provider and a second provider is provided. First, one or more first provider billing data structure are generated at the first provider based on services provided for the second provider. The billing data structure includes a rate element attribute that defines a chargeable unit. Next, an account of the total charges and total taxes from the one or more first providers data structures is stored as an accounts receivable for the first provider. Next, the one or more billing data structures is sent to the second provider. Next, one or more second provider billing data structures based on services provided for the first provider are received. The one or more second provider billing data structures are verified. An account of the total charges and total taxes from the one or more second providers data structure is stored as an accounts payable. The accounts payables and accounts receivables are reconciled at the end of a period.

In another embodiment, a program product is provided. The product comprises a computer readable medium having computer readable code means embodied therein for storing a billing data structure. The billing data structure includes a computer readable code means for storing an identification information and computer readable code means for storing billing information in one or more records containing one or more billing events. The billing information includes a rate element attribute for defining the unit of a rate the service is to be charged.

In another embodiment, a system for processing billing information is provided. Included is a first entity computer operable to generate a billing data structure having billing records comprising one or more billing events. Each of the one or more billing events is defined by a rate element attribute that denotes a chargeable unit. Also included is a second entity computer coupled to the first entity computer. The second entity computer is operable to access the billing information in the record and account for new charges as an accounts payable.

Technical benefits of the present invention may include one or more of the following benefits. The present invention provides a data structure for billing that has a fully definable charging unit. Also, the present invention provides a data structure having a file name that indicates sender, receiver and date information. Also, by providing a data structure written in extensible markeup language (XML) the data structure is human readable. The use of attributes indexed to table also provides flexibility to the system. The present invention also allows for an efficient way to process billing data structures and rejected incorrect billing records. The present invention also allows for an easy method and system for reconciling business-to-business charges. Other technical benefits are apparent from the following descriptions, illustrations and claims.

### BRIEF DESCRIPTION OF THE DRAWINGS

Non-limiting and non-exhaustive preferred embodiments of the present invention are described with references to the following figures wherein like reference numerals refer to like parts throughout the various views unless otherwise specified.

FIG. 1 is a diagram of an exemplary cellular phone system;

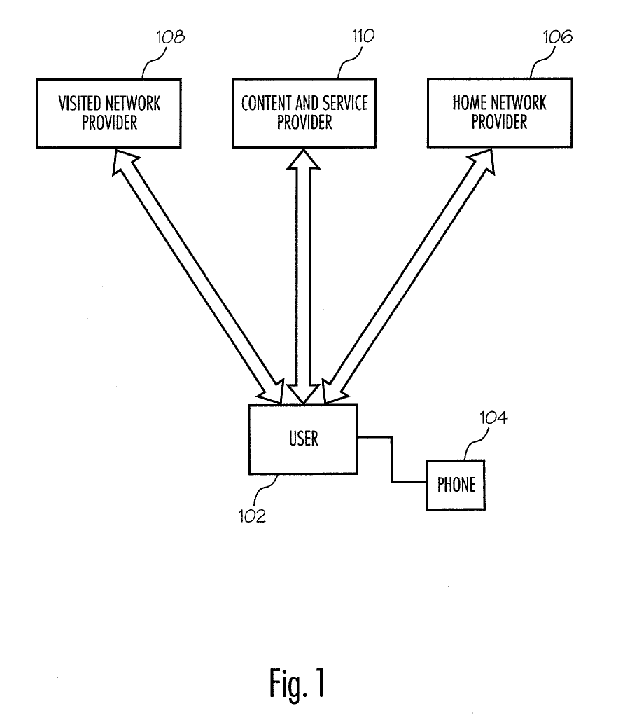

FIG. 2 is a block diagram of a billing system;

FIG. 3 is a block diagram of a data structure;

FIG. 4 is a detailed layout of the data structure;

FIG. 5 is a block diagram of an envelope processing system;

FIG. 6 is a block diagram of a message processing system;

FIG. 7 is a block diagram of a complete envelope return;

FIG. 8 is a block diagram of a partial envelope return;

FIG. 9 is a flow chart of a settlement process; and

FIG. 10 is a flow chart of a settlement process using a third-party processor.

### DETAILED DESCRIPTION OF THE INVENTION

The following descriptions and figures use cellular phone services billing as an exemplary embodiment. However, the present invention may be used for billing reconciliation between parties regardless of the type of services provided. For example, the present invention can be used to reconcile billing between providers of any type of wireless service including, voice, data, e-commerce, and the like. The present invention can also be used between any two business entities wishing to reconcile billings between the entities for services provided by one party or the other, or by an exchange of services provided between the parties.

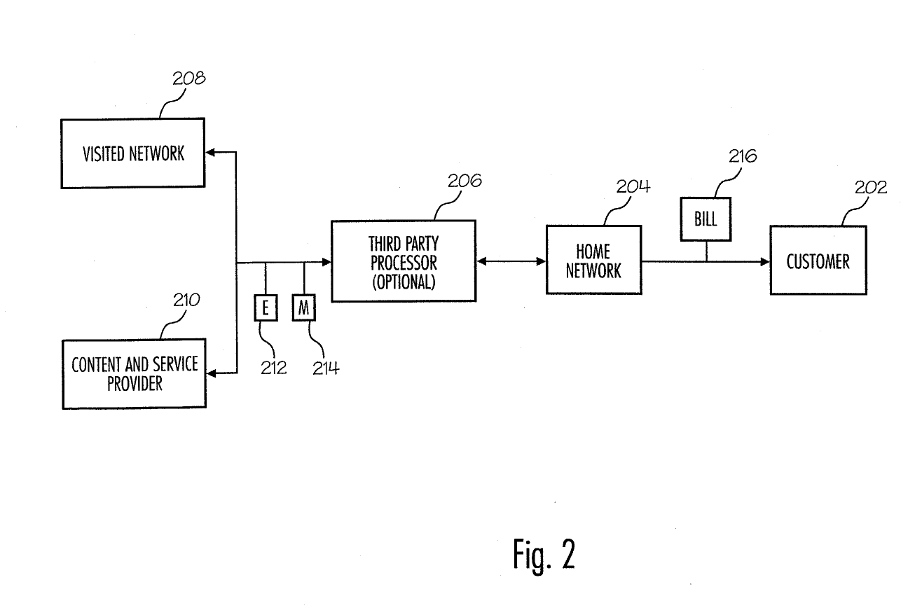

FIG. 2 is a block diagram of a billing system in accordance with the teachings of the present invention. Billing system 200 includes a customer 202, a home network operator 204, a visited network operator 208, a content and service provider 210 and an optional third party processor 206.

Home network operator 204 is the billing entity for customer 202. Home network operator 204 typically defines the terms of service for a customer based on a geographical home area and a number of minutes per month usage plan. Home network operator 204 may also have agreements with visited network operator 208 and content and service provider 210 to provide services to the customer 202 of home network operator 204. These services include roaming services and Internet services.

Visited network operator 208 is a network operator outside the service area of the home network operator 204. When customer 202 is using a cellular phone in an area controlled by the visited network operator 208, the visited network operator 208 tracks the usage and send a billing record or billing data structure, in the present example as a novel billing record envelope 212 or billing record message, to either the third-party processor 206 or directly to home network operator 204. Billing envelopes typically contain one or more billing records while billing messages contain a single billing record. The choice between using an envelope or a message 214 is a decision made between the various parties to a transaction. Of course, home network operator 204 can also act as a visited network operator 208 for customers of the visited network operator 208 and vice versa. The actual design and use of record envelope 212 is discussed in further detail below.

Content and service provider 210 can be any one of many different types of service providers such as a SMS provider, m-commerce vendors and the like. When a customer 202 uses a service provided by content and service provider 210, content and service provider 210 will send billing information to either third party processor 206 or directly to home network provider 204. In the present invention, billing information is sent using record envelopes 212 or record messages 214. The choice between using an envelope or a message 214 is a decision made between the various parties to a transaction.

Third-party processor 206 is an optional part of system 200. Third-party processor 206 receives record envelopes 212 and/or record messages 214 from visited network operator 208 or content and service providers 210. Third-party processor 206 then performs various validation and processing steps that will be described in greater detail below. Third-party processor 206 can then send statements to the billing parties regarding monies owed for services and then act as a clearinghouse for the transfer of money to settle billing between the business entities. Third-party processor 206 could also act as a translation entity by receiving data structures of the present invention from one party, translating the data structure to a legacy data structure like TAP or CIBER, and sending the legacy data structure on to a second party. Of course, the process could operate in reverse with the reception of a legacy data structure and the sending of a data structure of the present invention. The translation can occur by mapping values from one data structure to another. Home network operator 204 can also directly provide the same functionality, as will be discussed below.

In operation, customer 202 during a billing period has made calls within the network run by his home network operator 204. Customer 202 has also made roaming calls in the areas operated by one or more visited network operators 208. In addition, customer 202 has accessed the Internet using his cellular phone to check e-mail and make movie reservations, thus utilizing the services of one or more content and service providers 210.

At the end of the billing period, home network operator 204 receives billing information from service providers such as visited network operator 208 and content and service provider 210. This information is sent as billing records in a data structure. In the present invention, the data structure is either an envelope 212 or a message 214. Envelope 212 contains zero or more billing records. Envelope 212 could contain no billing records if the envelope 212 is sent without a record to denote that no billing information was processed for a certain period of time. Also, during the validation of the records in envelope 212, if all the records fail validation they are removed from the envelope, leaving an envelope 212 with no records. Message 214 always contains one billing record. The choice of whether to exchange envelopes or messages in a system is decided on by the parties to the exchange.

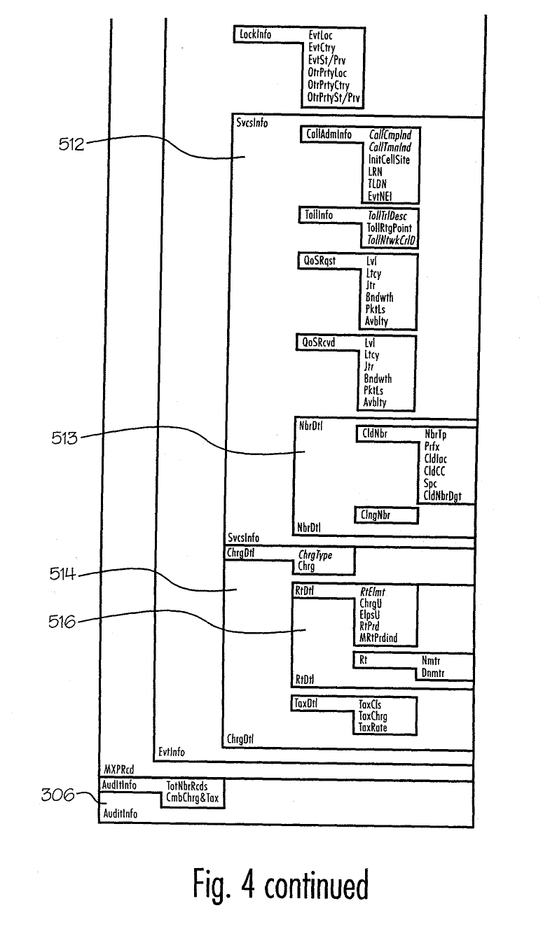

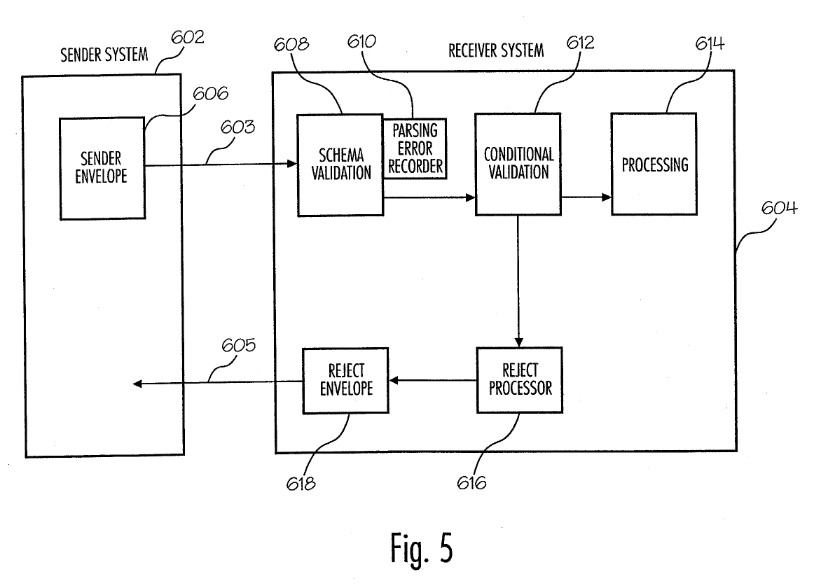

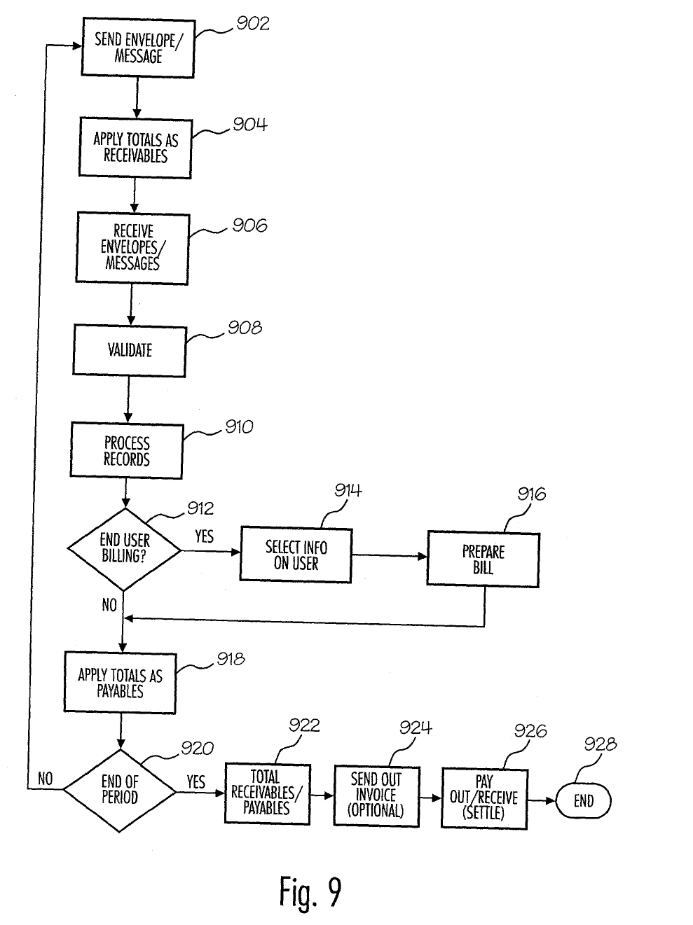

Home network operator 204 validates the envelope or message as well as the records in the envelope or message for proper format and perform an audit check on the information. This is discussed in greater detail in conjunction with FIGS. 5 and 6. The billing records can then be processed and bills for each individual customer 202 can be generated. Also, bills between the parties such as the home network operator 204 and the visited network operator 208 can be generated. Optionally, a third party processor 206 can be used to validate and process the envelopes 212 and messages 214. The optional third party processor can then send settlement information to the parties to the transaction. Thus, either the home network operator 204 or the third party processor or a similar party can operate as a bill processing entity. Also, at the end of a billing period, the different providers (home network operator, visited network operator and content and service provider) can settle billing issues between each other. This is discussed in further detail in conjunction with FIG. 9.

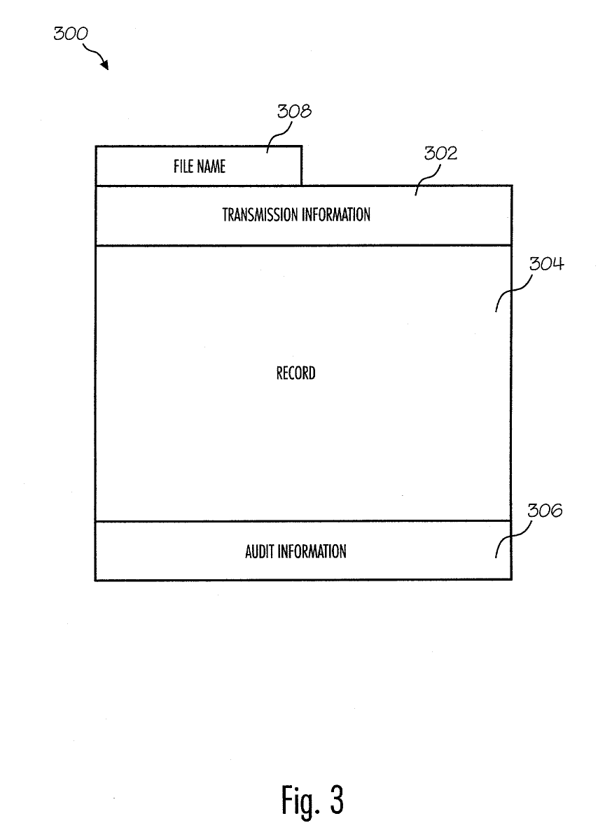

FIG. 3 illustrates an exemplary data structure 300 such as a billing envelope 212 or billing message 214 in accordance with the teachings of the present invention. A billing envelope 212 typically contains one or more billing records. In certain situations billing envelopes 212 contain no billing records. Billing messages 214 contain one billing record. Data structure 300 transfers billing information from a sending party to a receiving party. Data structure 300 comprises a transmission information section 302, a record section 304, and an audit information section 306.

Record section 304 includes detailed billing information. Data structure 300 can include one or more record sections 301. Record section 304 can include one or more of the following three types of records: a service record, an aggregate record or a reject record. Service records are records sent by an entity such as a service provider 210 or a visited network operator 208 that bill service usage to a specific party such as a specific user or customer. These records include billing exchange details for services such as Internet access, roaming usage and the like. Aggregate records are records sent between entities that include bulk-billing details but do not include individual end-user details. An example of an aggregate record would be bulk traffic information sent between two companies to settle usage between companies without the need for individual user identification. Reject records are service or aggregate records that are returned to the sender after processing due to such problems as invalid data or disputed charges.

Associated with each envelope 212 or message 214 is a unique filename 308. The elements of the filename include: (1) a test/charge indicator; (2) a file content indicator; (3) a sender identification; (4) a receiver identification; (5) an unique identification number; and (6) a .xml extension.

The test/charge indicator is an alphabetic entry of either a “T” or a “C” that identifies a file as either a test file or a charge file. Test files are used for testing the system to ensure the record formats are readable and correct. Charge files contain actual billable data or any other charge, credits and/or tax information on various transactions.

File content indicator indicates the contents of the envelope. In one embodiment there are five possible values for file content indicator: a “1” which identifies the file as an original (non-returned) envelope; a “2” which designates the file as an original message; a “3” which designates the file as a return envelope (complete); a “4” which identifies the files as a return envelope (partial) and a “5” which designates the file as a return message.

An original envelope has a content indicator a value of one (1) and is an envelope containing, typically, a plurality of service and/or aggregate records. An original message is a single aggregate or service record being sent for the first time. It has a content indicator value of two (2). A return envelope (complete) has a content indicator value of three (3) and is an envelope in which all the records that were originally sent are returned due to errors in the transmission information and/or audit information. The payload is the same as the original envelope. The return envelope (partial) indicator has a content indicator value of four (4). It is used to return one or more individual records that fail processing due to the individual records having errors. The return message indicator has a content indicator value of five (5) and is used when a message fails processing and the record is returned.

Sender information identifies the party that originated the data structure 300 (i.e. the envelope 212 or message 214). Depending on the embodiment, sender information can be a system identification number (SID); a billing identification number (BID); a public mobile network (PMN) identification network; a business resource identifier (BRI), and the like. SIDs and BIDs are five digit alphanumeric identifiers that are well known in the art. A BRI may consist of a three-digit alphanumeric country code followed by a four digit alphanumeric entity ID that is followed by a two digit numerical market ID. The size of the field for BRI's and their order are a method of design choice and can vary. In one embodiment, a company such as CIBERNET of Washington, D.C. is the issuer of the BRI and assigns both the country code and the entity code to identify the company and the country where the company operates. The market ID is assigned by the entity to which the BRI is assigned. BRIs are similar to BIDs except that a company that acquires a BRI from an issuing entity, such as CIBERNET, automatically acquires one hundred market identification numbers. A BID only gives one market ID per BID. Also BIDs are typically used by wireless carriers. BRIs can be acquired by any entity. The flexibility of using a BRI as an identifier extends the use of the present invention beyond traditional wireless application to any billing application between parties.

The receiver information identifies the party receiving the envelope 212 or message 214. The same types of identifiers as those used for sender identification can be used. The type of the receiver identification can be different from the type of the sender identification. For example, the sender identification can be expressed using a BRI while the receiver identification can be SID.

The identification number element is either an envelope identification number or a message identification number. Depending on if the data structure 300 in question is an envelope 212 or a message 214. In one embodiment the identification number takes the form of: aa-nnnnnn-yyddd where aa is a letter prefix, nnnnnn is a six digit identifier and yyddd is the modified julian date that includes the year and the day of the year (001 through 365 days for no leap years). Different two letter prefixes can be used to distinguish between envelopes and messages. For example, envelopes can have prefixes YY, YZ, ZY or ZZ assigned while messages can have any other combination.

In one embodiment, the records will be sent as XML files XML stands for Extensible Markup Language and allows designers of data structures to create custom tags and enables the definition, transmission, validation and interpretation of data between application and organization. If the files are XML files, then the extension .xml will be added to the filename.

Considering the foregoing, an original envelope that uses SIDs for sender information can have a filename 308 such as:

C166666;77777;YZ-321587-01056.xml

This particular filename 308 means that this data structure 300 is a charge file (the first C) for an original envelop (the “1”). The sending SID is 66666 and the receiving SID is 77777. The identification number element includes the modified Julian date of 01056, which means it was sent on the 56^{th} day of 2001. Such a file name allows for information to be learned about the contents of envelopes without examining the individual records. Also, such a file name can be examined by a computer program for proper format. The computer program can then reject envelopes and messages that do not fit the proper format.

Audit information section 306 includes the number of records and the total amount of charges for all the records. Each individual record in an envelope also includes charge information for that record. The audit information section 306 is typically included as a trailer section although it could be integrated with the transmission information.

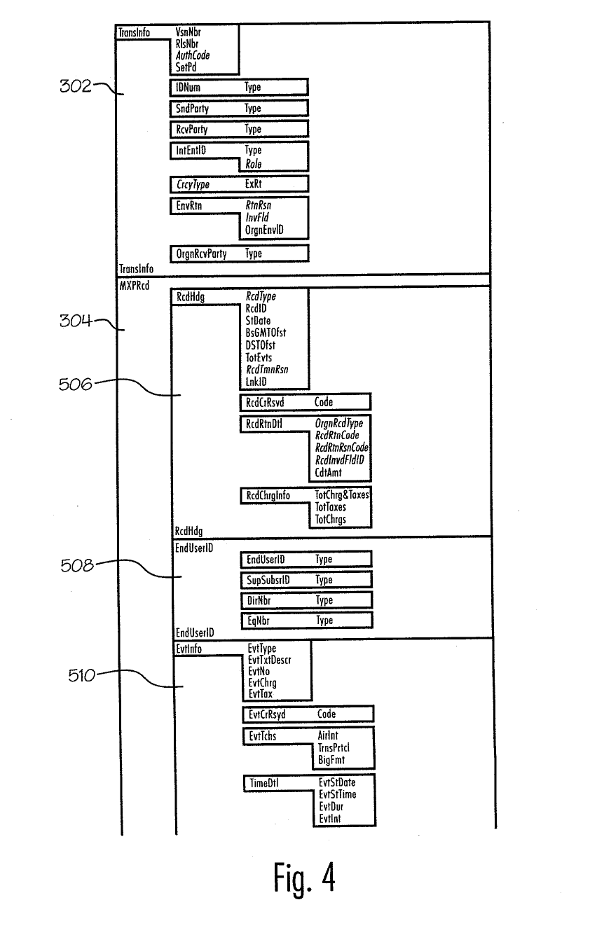

FIG. 4 illustrates data structure 300 in greater detail. Data structure 300 includes a transmission information section 302, a record section 304 and an audit information section 306. The audit information section 306 in this embodiment is in a trailer. In one embodiment, as discussed previously, there are three types of records: service records, aggregate records and reject records. Each section includes elements and attributes that store values used to identify records and define the billing information. Some of the various elements and attributes store values that are used in conjunction with look up tables. The values stored in the elements or attributes are indexed to entries in the table. The advantage of using tables is that more information can be stored in a smaller record. Also, tables can be easily changed and modified. While elements and attributes are discussed as being present in certain sections or subsections of data structure 300 the actual location of the various elements, attributes, subsection and sections of data structure 300 can be altered. Indeed, some of the elements, attributes, sections and subsections may not be present in every data structure 300 used for billing purposes. For example, an original message or envelope would not have any attributes or elements filled in that describe the return of an envelope or message since the envelope or message has not been rejected and is not a return envelope or message.

Transmission information section 302 includes various elements and attributes that are used to identify information concerning the entire data structure 300, such as the parties to the transaction. The transmission information section may include an identification number element (IDNum); a sending party element (SndPrty); a receiving party element (RcvPrty); an interim identification number element (IntEntID); a currency type element (CrcyType); an envelope return element (EnvRtn); and an original receiving party element (OrgnRcvPrty).

The identification number element stores the identification number of the envelope (if the file is an envelope) or the record, if the file is a message. The identification number element includes a type attribute, the value of which indicates if the identification number is an envelope identification or a message identification. The identification number element, in one embodiment is the same identification number that is part of the filename for the envelope message. That is, in one embodiment, it is in the form of aa-nnnnnn-yyddd as discussed in conjunction with FIG. 3. Of course, any unique identification number can be used.

The sending party element stores the identity of the business entity sending the file. The identity can be stored using a SID, BID, BRI, or the like. The receiving party element stores the identity of the receiving entity using a SID, BID, BRI, or the like. Both the sending party element and the receiving party element have an associated type attribute that stores an indicator identifying if the stored ID is a SID, BID, BRI or some other identifier. The interim entity identification element stores the identity of the business entity that processes the envelope or message in the case where a third party processes the envelope or message. The interim identity number is typically stored as BID/SID, BRI or PMN. The interim entity identification element includes attributes such as a role attribute that is used to denote the type of entity processing the file. The value stored in the role attribute is used in conjunction with a table to determine the type of entity. Also included is a type entity that denotes the type of identification stored in the interim entity identification element.

The currency type element stores the currency type (American dollars, Euro, Hong Kong dollars) used in the charge fields. An exchange rate attribute is included with the currency element. This stores the exchange rate from the sending party currency to the settlement currency in the case when the currency is different between the parties. The envelope return element is only used when an envelope is being returned. This element has a variety of attributes listed in the table below.

| Attribute | Definition |
|---|---|
| RtnRsn | Provides the reason the |
| (Return Reason) | envelope was returned. |
| | Attribute value is table- |
| | based. For complete envelope |
| | returns only. |
| InvFld | For returned envelopes this |
| (Invalid Field) | value indicates which field |
| | contained invalid values. Is |
| | used for complete returns. |
| | The value stored is also |
| | table based. |
| OrgnEnvID | This attribute stores the |
| (Original Envelope ID) | original envelope ID for all |
| | envelope returns, partial or |
| | complete. Not used with |
| | messages. |

The original receiving party identification element stores the identity of the business entity that was supposed to have received the envelope or message in the case of a returned envelope (partial or complete) or a returned message. Can be a SID/BID, BRI or PMN. It is only used with return messages or envelopes.

Transmission information section 302 also includes several other attributes listed in the table below.

| Attribute | Definition |
|---|---|
| VsnNbr | This attribute indicates the |
| (Version Number) | version number of the data |
| | structure. |
| RlsNbr | This attribute indicates the |
| (Release Number) | release number of the data |
| | structure. |
| AuthCode | This value is the original |
| (Authorization Code) | sending authorization code |
| | and is used in conjunction |
| | with a table to determine |
| | authorizations. |
| SetPd | This value gives the month |
| (Settlement Period) | the envelope or message falls |
| | under for settlement |
| | purposes. |

Record section 304 provides information regarding the individual records in the envelope or message. Record section 304 contains billing information regarding billing events occurring in a single session or usage, such as a single call or a single Internet session. As discussed previously, an envelope 212 can have more than one record section 304, each relating to a different usage session (or, in some case a single session may have billing information broken up in to multiple records if the billing information is recorded at different times). This is beneficial over previous data structure that allowed only the transmission of one record at a time. For example, by sending multiple records with a single transmission information section, the chance of rejection due to incorrect transmission information is decreased since less data structures need be sent. Also, the amount of processing is reduced since fewer data structures need to be sent. Record section 304 includes various subsections including a record heading subsection 506, an end user identification subsection 508, and an event information subsection 510.

Record heading subsection 506 includes information common to all events within a record. These can include the attributes listed in the table below:

| Attribute | Definition |
|---|---|
| RcdType | The value of this attribute |
| (Record Type) | indicates the type of record |
| | such as service, aggregate or |
| | return. The value is used in |
| | conjunction with a table to |
| | determine the type of record. |
| RcdID | The value of this attribute |
| (Record ID) | indicates the individual |
| | record identification number. |
| | Not present in messages |
| | because there is only one |
| | record in a message. |
| StDate | The value of this attribute |
| (Start Date) | indicates the starting date |
| | of the session or usage in |
| | the record. |
| BSGMTofst | The value of this attribute |
| (Base GMT Offset) | indicates the offset of the |
| | subscriber/served party from |
| | Greenwich mean time (GMT). |
| | This is used to normalize the |
| | time. |
| DSTOfst | The value of this attribute |
| (Daylight Savings Time | indicates if daylight savings |
| Offset) | time is in effect in location |
| | where service is provided. |
| TotEvts | The value of this attribute |
| (Total Events) | indicates the total number of |
| | events in a single record. |
| | If multiple billing events |
| | occur during a single session |
| | or usage, multiple event |
| | information sections will be |
| | formed to track the events. |
| | This attribute stores the |
| | total number of those events. |
| RcdTmnRsn | If the record is terminated |
| (Record Termination Reason) | for any reason out of the |
| | normal, this value provides a |
| | lookup number for a table to |
| | determine the reason for |
| | termination. |
| LinkID | This field is used to link |
| (Link ID) | different records that |
| | contain billing data for the |
| | same session or usage. An |
| | example is if airtime is sent |
| | in one record and toll |
| | charges for the same call is |
| | sent in another record. |

The record heading subsection 506 also includes an optional record carrier reserved field that contains information regarding non-standard information transfer. This field can contain any information the sending and receiving parties agree to add. Record heading reserve field contains an optional attribute that signals the receiving party that data is in the record carrier reserved field.

Record heading subsection 506 also includes a record return detail element, which contains information regarding rejected records. Obviously, this subsection would not be present in an original envelope or message. Rejected records are returned to the sender as return record in either a new envelope (for a return of less then all of the records), in the same envelope if all records are returned or in a message if the original data structure 300 was a message. This section is populated only if the data structure is a return envelope or a return message.

The record return detail element comprises several attributes listed in the following table.

| Attribute | Definition |
|---|---|
| OrgnRcdType | In one embodiment, the value |
| (Original Record Type) | is used in conjunction with a |
| | table of values. This value |
| | indicates the original type |
| | of record that was sent, such |
| | as a service record or an |
| | aggregate record. |
| RcdRtnCode | In one embodiment, the value |
| (Record Return Code) | is used in conjunction with a |
| | table of values. This value |
| | provides information about |
| | the type of credit (full or |
| | partial), as well identifying |
| | invalid returns. |
| RcdRtnRsnCode | This value shows the reason |
| (Record Return Reason Code) | why the original receiving |
| | party did not accept the |
| | record. This value is |
| | matched to a table of |
| | reasons. |
| RcdInvdFldID | This field indicates which |
| (Record Invalid Field ID) | fields in the record caused |
| | the record to be returned. |
| | (Table-Based). |
| CtdAmt | This field indicates |
| (Credit Amount) | financial value of the |
| | records not being returned. |

The record heading subsection 506 also includes a record charge information element that contains information regarding the total charges and taxes (and credits if any) for all the events in a record. The record charge information element includes the attributes listed in the following table.

| Attribute | Definition |
|---|---|
| TotChrg&Taxes | Total currency amount owed to |
| (Total Charges and Taxes) | sending party for all events |
| | in a record. This may be a |
| | credit or a debit |
| TotTaxes | Total tax amount due for all |
| (Total Taxes) | events in a record. |
| TotChrgs | Total charges and credits due |
| (Total Charges) | to sending party less taxes |
| | for the listed event. |

The end user identification section 510 is used to identify the individual who initiated the services listed in the event section of the record or the individual for who service was initiated. The end user identification section 510 comprises several elements and their associated attributes. One element is the EndUserID element that contains an attribute whose value identifies the user receiving the service. Example of identification numbers is a MIN, IMSI, or NEI. Associated with the end user ID element is a type attribute used to determine what type of identification was used. Another element is the SupSubsrId element that contains an attribute whose value contains the subscriber number as issued by the company maintaining the record protocol. Associated with this element is a type attribute used to determine what type of identification number is being used. A directory number attribute (DirNbr) stores directory number of the end user. This element is used for voice calls only. The directory number element has an attribute that indicates if a mobile directory number (MDN) or MSISDN is available. The equipment number field (EqNbr) stores the number of the equipment the end user is using such as the electronic serial number (ESN) or international mobile equipment identity (IMEI) number. Associated with this element is a type attribute used to determine what type of identification number is being used.

The Events Information section 510 lists the events that are attributable to the subscriber identified in the end user identification section 508. There can be multiple event information sections 510 in a single record. Each event in event information section 512 occurs in the same usage session or period. This is beneficial over previous systems, which required a separate record for each event. For example, by including multiple events per record, only one set of record parameters need to be sent, decreasing the chance of poorly formed records. Also, less processing will be involved. The following table lists examples of attributes that may be present in the Event Information section 510.

| Attribute | Definition |
|---|---|
| EvtType | This field is used to show |
| (Event Type) | the type of event being |
| | recorded and/or charged. It |
| | provides a value that is used |
| | to match an event listed in a |
| | table. |
| EvtTxtDescr | This field provides a text |
| (Event Type Description) | description of the service |
| | provided. |
| EvtNo | This attribute is a |
| (Event Number) | cumulative counter of the |
| | events in the record. |
| EvtChrg | This field contains the |
| (Event Charge) | charge amount (less taxes) |
| | for the event in the event |
| | info Section. Can be a debit |
| | or a credit. |
| EvtTax | This field lists the taxes |
| (Event Tax) | charged to an event. |

Event information section 510 also includes an event carrier reserve element. This element can be customized by providers to send other information regarding an event. Both the sending and receiving parties need to agree to content for this element. This element includes a code attribute that alerts if data is included the carrier reserve element.

Event information section 510 also includes an event technologies field that records the technologies used during the event. The event technology element may include one or more of the following attributes.

| Attribute | Definition |
|---|---|
| AirInt | For wireless usage, records |
| (Air Interface) | the type of air interface |
| | used to support the event. |
| TrnsPrtcl | For data usage, records the |
| (Transmission Protocol) | transport protocol used |
| | during the event. |
| BlgFmt | For records that have been |
| (Billing Format) | converted from other formats |
| | into MXP, this field provides |
| | the original format prior to |
| | the conversion. |

Event information section 510 also includes a time detail element, for storing tome and duration information of the event and a location information element for storing information regarding the location of the event. The following table lists attributes of the time detail element.

| Attribute | Definition |
|---|---|
| EvtStDate | This attribute lists the date |
| (Event Start Date) | the event started. |
| EvtStTime | This attribute indicates the |
| (Event Start Time) | time the event started. |
| EvtDur | This attribute indicates the |
| (Event Duration) | elapsed duration of an event. |
| EvtInt | This attribute is used to |
| (Event Interval) | define a service as either a |
| | push service (supplied to the |
| | user) or a pull service (user |
| | requested). This attribute |
| | also supplies the |
| | chronological period used to |
| | define the event. |

The location element contains information regarding an event's origination and terminating location. Example attributes of the location element are listed in the following table.

| Attribute | Definition |
|---|---|
| EvtLoc | For Service Records, the |
| (Event Location) | detailed location of the end |
| | user. For Aggregate Records, |
| | the location of the primary |
| | equipment providing the |
| | service being charged. Will |
| | normally be a city, though |
| | the actual level of |
| | granularity is at the |
| | sender's discretion. |
| EvtCtry | For Service Records, the |
| (Event Country) | country where the end user |
| | used the service. For |
| | Aggregate Records, the |
| | country of the primary |
| | equipment providing the |
| | service being charged. |
| EvtSt/Prov | For Service Records, the |
| (Event State Province) | state or province of the end |
| | user when the service was |
| | initiated. For Aggregate |
| | Records, the location of the |
| | primary equipment providing |
| | the service being charged. |
| OtrPrtyLoc | For Service Records, the |
| (Other Party Location) | detailed location of the |
| | other party, if applicable. |
| | Will normally be a city, |
| | though the actual level of |
| | granularity is at the |
| | sender's discretion. |
| OtrPrtyCtry | The country where the other |
| (Other Party Country) | party is located, if |
| | available. |
| OtrPrtySt/Prov | The state/province of the |
| (Other Party State/Province) | other party, if available |

Event information section 510 also includes a service information element subsection 512 that provides information regarding quality of service, toll information and call administration information. The service information element includes a call administration information element, a toll information element, a quality of service requested element, a quality of service received element and a number detail element.

Call administration information element includes information for administrating a call. The table below lists attributes of the call administration information element.

| Attribute | Definition |
|---|---|
| CallCmpInd | This attribute indicates how |
| (Call Completion Indication) | a call was completed. |
| | Examples of completing a call |
| | include call incomplete or |
| | party answered. Typically |
| | the value is used in |
| | conjunction with a look-up |
| | table. |
| CallTmnInd | This attribute indicates how |
| (Call Termination Indication) | a call was ended. Typically |
| | the value is used in |
| | conjunction with a look-up |
| | table. |
| InitCellSite | This attribute holds the cell |
| (Initial Cell Site) | site number of where the call |
| | was initiated or received |
| LRN | This attribute records the |
| (Local Routing Number) | routing number associated |
| | with a ported mobile |
| | directory number, when the |
| | end user's mobile phone |
| | number has been ported. |
| TLDN | This attribute holds the |
| (Temporary Local Directory | temporary local directory |
| Number) | number (TLDN) assigned to a |
| | mobile system by the serving |
| | carrier when the mobile |
| | station is roaming. |
| EvtNEI | This attribute contains the |
| (Event Number Equipment | NEI of the wireless equipment |
| Identifier) | for the event. |

The toll information element provides information regarding toll calls for wireless usage and for landline usage when toll calls are made. The following table lists the attributes of the toll information element.

| Attribute | Definition |
|---|---|
| TollTrfDesc | This attribute provides the |
| (Toll Tariff Description) | call origination/termination |
| | information for toll calls |
| TollRtgPoint | This attribute holds the |
| (Toll Rating Point) | location wired (landline) |
| | connection point for the |
| | wireless call. |
| TollNtwkCrID | This attribute is used to |
| (Toll Network Carrier ID) | identify the land line |
| | carrier that was used to |
| | complete the call. |

The quality of service requested element and the quality of service received element track the quality of service requested for data services and the quality of service received for data service. Both elements have similar attributes that are listed in the table below.

| Attribute | Definition |
|---|---|
| Lvl | This attribute indicates the |
| (Level) | transfer delay for general |
| | packet radio service. |
| Ltcy | This attribute gives the menu |
| (Latency) | throughput for data |
| | connections. |
| Jtr | This attribute indicates the |
| (Jitter) | peak throughput for data |
| | connections. |
| Bndwth | This attribute indicates the |
| (Bandwidth) | procedure available for data |
| | connections. |
| PktLs | This attribute indicates the |
| (Packet Loss) | reliability for data |
| | connections. |
| Avblty | This attribute indicates the |
| (Availability) | network availability. |

The number detail section is used to identify the called and calling number. This section includes a called number detail element and a calling number element. The called number detail element provides the dialed digits of the end user originated calls. The table below lists attributes of the called number detail element.

| Attribute | Definition |
|---|---|
| NbrTp | This attribute stores the |
| (Number Type) | type of number dialed. The |
| | value is used in conjunction |
| | with a look up. |
| Prfx | This attribute stores any |
| (Prefix) | number entered before the |
| | dialed number, country code |
| | (cc) or the international |
| | access code (IAC) |
| CldIAC | This attribute stores the |
| (Called International Access | international access code |
| Code) | dialed, if dialed. |
| CldCC | This attribute stores the |
| (Called Country Code) | country code dialed. |
| SPC | This attribute stores special |
| (Special) | keys dialed such as # or *. |
| CldNbrDgt | This attribute stores the |
| (Called Number Digits) | called number excluding the |
| | IAC or CC. |

Calling number element is an optional element that stores the number of the dialing party for end-user terminated calls.

Charge detail subsection 514 contains the charge information associated with the event. This section may occur more than once to accommodate more than one event. The charge detail element includes a charge type (chrgtype) attribute that identifies the category of charge being applied such as a wireless call or packet data transfer. There can be any number of charges for a single event. This is advantageous over previous systems that only allow a minimum of charges per service. Also included is a charge attribute that lists the charges or credits in the record currency for that charge detail section.

Included within the charge detail section 512 is a rate detail section 513 that is used to identify information regarding the rating methods used in the record. The rate detail element has attributes that allow for the billing of such conventional units as packets or minutes. It can also allow for billing of any other services using customer definable units such as the unit “lives” in an online game where extra lives can purchased. The rate detail element comprises several attributes listed in the table below.

| Attribute | Definition |
|---|---|
| RateElmt | This attribute is used to |
| (Rate Element) | determine the charge. The |
| | value in the field is used to |
| | look up a value in a rate |
| | element table. The rate |
| | element could be minutes or |
| | packets. It can also be any |
| | other unit or item for which |
| | the content and service |
| | provider wishes to charge. |
| | (Table based). |
| ChrgU | This attribute indicates the |
| (Charge Units) | number of units used to |
| | determine the charge. |
| ElpsU | This attribute contains the |
| (Elapsed Units) | actual units used. It may |
| | differ from chargeable units |
| | if rounding is used. |
| RatePeriod | This attribute rates the |
| (Rate Period) | period of service, such as a |
| | call. The value is used to |
| | look up a period on a rate |
| | period table |
| MratePrdInd | This attribute is used if the |
| (Multiple Rate Period | service crossed over multiple |
| Indicator) | rate periods such as call |
| | initiated in a day period and |
| | ending in an evening period. |

Rate detail section 512 also includes a rate element used to store the rate used to determine the charge per rate element. It includes a numerator attribute (Nmtr) and a denominator attribute (Dnmtr). The numerator attribute gives the currency amount for the rate. The denominator attribute gives the units for the rate. For example, for a 2.00 US dollar per minute rate, the numerator attribute would be a 2 and the denominator attribute would be a 1.

Charge detail section 512 includes a tax detail element that contains information on taxes to the event. The table below list attributes associated with the tax detail element.

| Attribute | Definition |
|---|---|
| TaxCls | This attribute identifies the |
| (Tax Class) | type of tax applied on the |
| | event. The value is used in |
| | a lookup table |
| TaxChrg | This attribute stores the tax |
| (Tax Charge) | charges associated with an |
| | event. |
| Taxrate | This attribute stores the tax |
| (Tax Rate) | rate used, typically as a |
| | percentage |

Associated with the record is an audit information section 306. The audit information section contains the audit information for all the records in an envelope. The attributes associated with the audit information section include the total number of records (TotNbrRcds), which is a count of the number of records in an envelope and the combined charge and tax attribute (CmbChg&Tax), which is a total of all the charges associated with the records. Audit information section 306 can be included in a footer or trailer to the record.

FIG. 5 is a block diagram of the envelope processing process. Illustrated are a sender system 602 and a receiver system 604. Sender system 602 originates a sender envelope 606. Receiver system 604 receives the envelope and includes a schema validation engine 608 coupled to a parsing editor recorder 610 and a conditional validation engine 612. Conditional validation engine 612 is coupled to a processing engine 614 and a reject processor 616 which produces reject envelope 618.

Sender system 602 may be implemented as a computer system including a processor and a memory. Sender system 602 is operable to collect billing information for one or more events occurring in one or more sessions and forming one or more envelopes 606. Sender system 602 is operated by, for example, a visited operator network or a content and service provider.

Receiver system 604 is also a computer system having a processor and a memory. In one embodiment, receiver system is the home operating network of FIG. 2. Also, receiver system 604 may be the third-party processor as disclosed in FIG. 2. Or, a third-party processor and the home network operator (or visited network operator) may share the responsibilities outlined below. Schema validation engine 608, conditional validation engine 612, processing engine 614 and reject processor 616 can all be implemented as programs running on a computer system. These can be implemented as one or more programs. Parsing error recorder can be implemented as a storage file in memory of the receiver system 604.

In operation, sender system 602 creates envelope 606 containing, in this example a plurality of records regarding one or more billing events. Sender envelope 606 is an original envelope that may comprise service records or aggregate records or both.

Sender system 602 forwards envelope 606 to receiver system 604 via connection 603. In one embodiment, connection 603 is a secure file transfer protocol (FTP) connection. Connection 603 may be any wired or wireless data connector such as a dedicated wired connection, a connection over a local area network or a wide area network, a connection over the Internet and the like. In one embodiment envelope 606 may be stored on removable storage media such as floppy disks or CD-ROM disks and sent to receiver system 604 via mail, courier and the like. In this case, connection 603 represents a manual transfer of the storage media.

At receiver system 604, a schema validation engine 608 is used to validate the envelope 606 against the expected record format or record schema. The expected record schema is a combination of the sections, elements and attributes shown in FIG. 4 with the applicable sections populated along with the knowledge of what type of values (alphabetical, numerical, alphanumerical) and size of values are expected. The schema validation engine 608 checks to see if the envelope 606 and the records contained within are properly formatted. This includes checking to see if invalid information such as alphabetical characters in an attribute reserved for numerical characters only, missing elements or attributes values and the like. As discussed earlier, in one embodiment envelope 606 and the records are written in XML format. In this case an XML parser, such as XML SPY, sold by Altova, Inc. of Beverly, Mass., can be used to perform the validation. Records that fail validation are recorded, along with the reasons for failures in error recorder 610.

After the initial schema validation, envelope 606 is forwarded to the conditional validation engine 612. At conditional validation engine several checks are performed. First, the transmission information in the transmission information section is verified. If the transmission information is in error, the entire envelope is rejected. The audit information section is also checked. If the auditing information values are incorrect, then the entire envelope is rejected. For elements and attributes of the envelope that require table look-ups, the values are cross-referenced against the tables to ensure that the records are properly populated. If not, the record fails. Then the different attribute values are crosschecked against other fields to ensure that the required and or related elements and attributes values exist and are properly formatted.

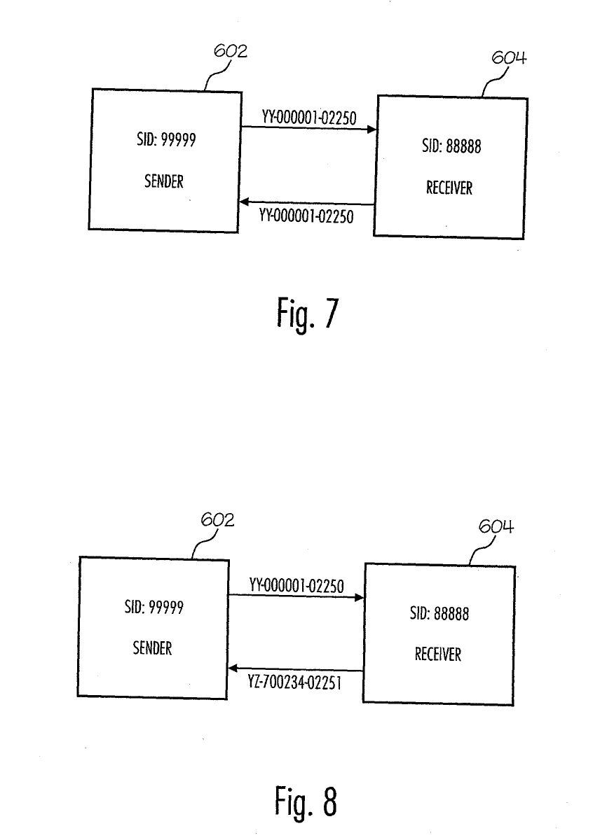

For the first two checks, if the entire envelope is rejected the entire envelope is returned. In the reject processor, the envelope is rejected and the element or attribute corresponding to the reason for return is populated. Individual records are not modified. One way to denote an envelope return is to populate the envelope return element in the transmission information section 512, which contains attributes for the reason for the return and for which attribute or element values are incorrect. This process is discussed in detail in conjunction with FIG. 8.

If individual records within an envelope fail, these records are removed from the envelope and the original envelope has its audit information changed. The rejected records are forwarded to the reject processor 616. Reject processor 616 converts the records to reject records. In one embodiment, the record return detail element of the record heading section is populated. The reject processor 616 then forms one or more reject envelopes 618 to send the reject records back to the sender via connection 605. Connection 605 can be the same type of connection as connection 603. This is discussed in further detail in conjunction with FIG. 8.

The individual records that were not rejected are in a modified envelope 606. This envelope is sent on for processing at processor 614. At processor 614 individual records are processed and billing can occur.

In an alternative embodiment, schema validation and/or conditional validation can be done by sender system 602. The validated records can then be forwarded to the receiver system 604. Or both the sender system 6032 and the receiver system 604 can perform schema validation and/or conditional validation as a check against each other. Validation can also be done entirely by a third-party. In that case, receiver system 604 is a third-party to the actual providing of services billed for.

FIG. 6 is a block diagram of the message processing process. Illustrated are a sender system 602 and a receiver system 604. Sender system 602 originates a sender message 702. Receiver system 604 includes a schema validation engine 608 coupled to a conditional validation engine 612. Conditional validation engine 612 is coupled to a processing engine 614 and a reject processor 616 which produces reject messages 704.

Sender system 602 is typically a computer system including a processor and a memory. Sender system 602 is operated by, for example, a visited operator network or a service provider.

Receiver system 604 is also a computer system having a processor and a memory. Schema validation engine 608, conditional validation engine 612, processing engine 614 and reject processor 616 can all be implemented as programs running on a computer system. These can be implemented as one or more programs.

In operation, sender system 602 creates message 702 containing a single record. Message 702 may comprise a service record or an aggregate record.

Message 702 is forwarded to receiver system 604 via connection 603. Connection 603 in one embodiment is a secure file transport protocol (FTP) connection although connection 603 may be any wired or wireless data connection such as a dedicated wired connection, a connection over a local area network or a wide area network, a connection over the Internet and the like. In one embodiment message 702 may be stored on removable storage media such as a floppy disk or CD-ROM disc and sent to receiver system 604 via mail, courier and the like. In this case, connection 603 would represent a manual transfer of the message 702 via a storage medium.

At the receiver system, a schema validation engine 608 is used to validate the message 702 against the record schema. Schema validation engine 608 checks to see if the message 702 and the record within are properly formatted. This includes checking to see if there is invalid information, such as invalid characters in a field, if tags are missing or open and the like. As discussed earlier, in one embodiment message 702 and the record within are written in XML format. In this case on XML parsers can be used to perform the validation. Messages 702 that fail validation are sent to reject processor 614.

If the initial schema validation is passed, the message 102 is forwarded to the conditional validation engine 612. The conditional validation engine performs several checks. First, the transmission information is verified. If the transmission information is in error, the message is rejected. Then, for elements or attributes of the record that require table look-ups, the value is cross-referenced against the tables to ensure that the record is properly populated. If not, the record fails. Thus the different element and attribute values are cross-checked against other fields to ensure the record is correctly populated.

If the message 702 fails any of the checks the message 702 is sent to the reject processor 616. There the original record is changed to a return record and returned to the sender in message format.

If the message 702 and record passes validation then the message 702 is sent on for further processing.

In an alternative embodiment, schema validation and/or conditional validation can be done by sender 602. The validated records can then be forwarded to the receiver 604. Or both the sender 603 and the receiver 604 can perform schema validation and/or conditional validation as a check against each other. Validation can also be done entirely by a third-party. In that case, receiver 604 is a third-party to the actual providing of services billed for.

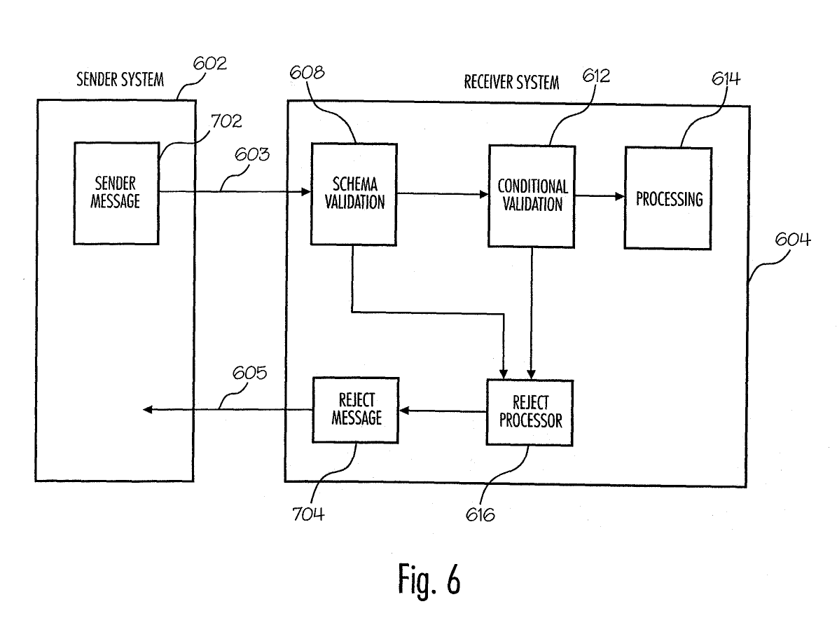

FIG. 7 is a block diagram illustrating a complete return of an envelope (or message). Illustrated is sender system 602 coupled to receiver system 604. Sender in this example has identification number of 99999 (corresponding to a SID or a BID). Receiver system has an identification number of 88888. Sender system 602 creates an envelope with an ID of YY-000001-02250. Since this is an original envelope and is not a test file, the file name will be: C199999;88888;YY-000001-02250. As discussed previously, the “1” in the second position is the identifier of an original envelope.

Sender system 602 forwards the envelope to the receiver system 604 where it is rejected because, for an envelope, the transmission data is invalid or the audit information is inaccurate. Since the entire envelope is rejected it is returned to sender's system without modifying any record. In the transmission information section 512, for the identification number, the sending party becomes the receiving party and the receiving party becomes the sending party. Thus the positions swap on the filename. In the transmission information section 512 the envelope return element is populated by populating the return reason attribute, the invalid field attribute, and the original envelope identification attribute. Also, in the record heading section the record return detail element is populated by including the reason for return (the RcdRtnRsnCode attribute), the invalid field identifier (the RcdInvdFldID), the record return code (RcdRtnCd) and the original record type (OrgnRcdType). In the example above, the return envelope will have a filename of C388888;99999;YY-000001-02250. The 3 in the second place indicates that this is a complete return.

FIG. 8 illustrates a partial envelope return. Again there is sender system 602 and receiver system 604. Sender system 602 creates an envelope of records. Again, for this example sender system 602 has an identification number of 99999 and receiver system 604 has an identification number of 88888. The envelope is assigned an identification number of YY-000002-02250 giving it a filename of C199999;88888;YY-000002-02250.

Sender system 602 forwards the envelope to receiver system 604. In this example, some of the individual records in the payload fail due to an element in the record riot in the proper format (such as poorly formed XML) or an attribute of an element being out of range or having a value not corresponding to a valid table value, in the case where the attribute value is used in a table look up. Once the records fail the invalid records are sent to the reject record processor. The records are changed to reject record under the record type attribute and the record return detail element is populated. Since the original file was an envelope, the return records are returned in an envelope. In this case, a new envelope is generated with a new file name. For example, the return envelope's filename may be: C488888;99999;YZ-700234-02251. The “4” in the second position indicates that this is a partial return. The identification number, YZ-700234-02251 is new because a new envelope is generated. In the transmission information section 512 the envelope return field (EnvRtn) is populated with the original envelope identification. Also, in the record heading section, the record return detail element is populated by including the reason for return (the RcdRtnRsnCode attribute), the invalid field identifier (the RcdInvdFldID), the record return code (RcdRtnCd) and the original record type (OrgnRcdType).

In the case of a return message, there is only one record so there is no partial return message. A message can fail for invalid transmission data, an element in the record not being in the proper format (such as poorly formed XML), an attribute of an element being out of range or having a value not corresponding to a valid table value, in the case where the attribute value is used in a table look up. Since this is a message that is being returned, the envelope return element in the information section is not populated. In the record heading section, the record return detail element is populated by including the reason for return (the RcdRtnRsnCode attribute), the invalid field identifier (the RcdInvdFldID), the record return code RcdRtnCd) and the original record type (OrgnRcdType).

FIG. 9 is a flowchart illustrating an exemplary settlement method. In this method, the parties to the method are outlined as in FIG. 2 with the exception of the third-party processor 206. In the method below, the visited network operator and the content and service provider will be exchanging billing information between themselves and the home network operator. In the example that follows those parties will be referred to as entities and parties.

In step 902, envelopes and/or messages are produced by an entity and sent to various parties. For example, an entity might be a cellular phone service provider and the envelopes and messages contain billing information regarding roaming charges. The envelopes and messages are sent to other cellular providers whose customers utilized the sending parties network while roaming.

In step 904 the total charges and total taxes for each envelope and message are noted as an accounts receivable in a computerized ledger system, accounting system database or similar system. A separate accounting is kept for each party with whom the sending entity has a billing relationship.

In step 906, the entity receives envelopes and messages from one or more parties with whom that entity has a billing relationship.

In step 908, the envelope and/or message is validated as described in FIGS. 7 and 8. In addition a rate audit can occur. A rate audit is when an entity checks the rate detail element and the rate element to ensure the agreed upon rate is being charged. In a record built on XML principles, the rate audit occurs by examining the values in the rate detail element against agreed upon values. For example, the rate element attribute may be checked to see if the proper rate element is defined. Also, the numerator attribute and the denominator attribute may be checked to see if the proper rate is being charged for the rate element. Other elements and attributes may be checked as well.

In step 910 all records that pass the audit check and validation step are processed. In step 912 it is determined if end user billing is to occur. The step of end user billing is optional and not part of the actual settlement procedure that deals with business-to-business transactions.

If end user billing is done, in step 914 information regarding the end user is extracted from the records. For example, the end user identification can be extracted along with event charges, event description, event duration, charged units and the like. All of the information for each end user is then processed against information for each user to determine the charges to the individual. Different users may have different billing plans. In addition, the information regarding charges in the record is typically wholesale charges. The end user's provider may adjust the wholesale charges up or down. Once all the necessary information is gathered and a billing cycle is completed, the bill is processed and sent to the end user in step 916.

Regardless of whether end user billing is done, in step 918 business-to-business settlement is initiated. In step 918, the total charges and total taxes of the records are matched to a billing partner's information and applied as a payable to a general ledger accounting system or the like. Typically the billing records contain charges for service rendered but may also include credits for events such as overpayments or rebates. In some cases both business entities may exchange billing records in either an envelope or message. In some cases, the transaction is one sided and one of the business entities sends billing information to the other for services provided while the other party does not supply any services and thus has no billing information to send. One example is when one of the business entities is a mobile Internet provider and the other entity is a home network operator. The mobile Internet operator will send billing information to the home network operator for Internet usage incurred by customers of the home network operator. However, the mobile Internet provider may never receive any billing information from the home network operator.

In any event, for each party that has a billing relationship with another party the total charges and total taxes from each record will be tracked as accounts payables and reconciled with any existing accounts receivables. In this way, a running total is kept of the accounts receivables, the accounts payables, and the net.

In step 920 it is determined if the end of a billing period has been reached. If not, the process can start again at step 902 with the exchanging of envelopes and messages. If the process is over, then in step 922, the end of the period totals are reconciled to get the end of the period receivables, payables and the net between the receivables and payables. In step 924, which is an optional step, invoices or reports regarding this information may be sent to each billing party. Then, according to agreements, customs, laws or otherwise, each party settles their bills either using netting or bilateral payments in step 926. The process ends in step 928.

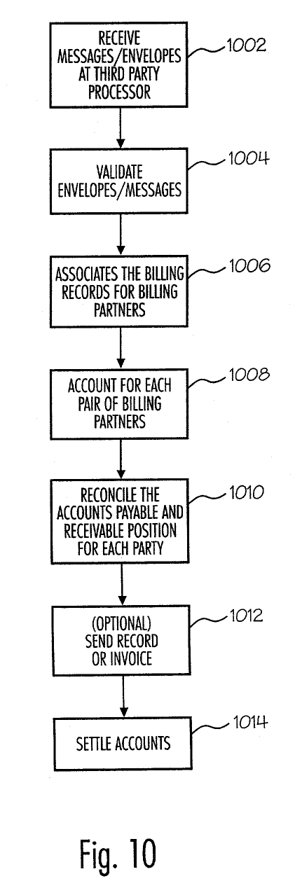

FIG. 10 is a flowchart for a method of reconciling billing between business entities using a third-party processor. The system employed is similar to that of FIG. 2.

In a first step 1002, third-party processors receives messages and envelopes from a variety of different billing entities.

In step 1004, the third party processor validates the messages and envelopes as shown in FIGS. 7 and 8 and returns rejected envelopes and rejected messages to the sender. The billing records that pass are then processed.

First, in step 1006, the third-party processor associates the billing records for billing partners together. Then, in step 1008, the third party processor keeps an account for the accounts receivables and accounts payable for each pair of billing partners based on the messages or envelopes sent out by the billing partners and those received by the third party processor on behalf of the billing partners.

At the end of a billing cycle, in step 1010, the third-party processor reconciles the accounts payable and receivable position for each party by verifying the value of billing records sent by a party and those received on behalf of the same party. The charges and credits from the billing records of the envelopes and messages are applied as appropriate. In step 1012, a record or invoice maybe sent to each party regarding their account. In step 1014, accounts are settled either directly by the parties or through the third party processor.

In the method described above, the third-party processor received, verified, and processed billing records in envelopes and messages. The third-party processor also accounted for the parties involved, reconciled the accounting and settled the payments. In an alternative embodiment, the parties to the transactions could perform the receiving, validating and processing steps while the third party processor performs the accounting, reconciliation and settlement steps. Alternatively, the parties to the transactions could perform the accounting, reconciliation and settlement steps while the third party processor performs the receiving, validating and processing steps.

Having now described preferred embodiments of the invention modifications and variations may occur to those skilled in the art. The invention is thus not limited to the preferred embodiments, but is instead set forth in the following clauses and legal equivalents thereof.

What is claimed:

1. A data structure for exchanging billing information between a first party and a second party comprising:
a transmission information section;
a record section containing billing information on one or more events, the record section including a rate element for defining a chargeable unit.

2. The data structure of claim 1 further comprising an audit section that includes an account of the total number of records in a data structure and an account of the total charges in the total number of records.

3. The data structure of claim 1 wherein the identification field includes a sender identification, a receiver identification and a data structure identification number.

4. The data structure of claim 1 further comprising a file name associated with the data structure, the file name including the senders identification, a receiver identification and a date identification.

5. The data structure of claim 3 wherein the sender identification is stored as a business resource identifier comprising a country code section, an entity code section and a market ID section.

6. The data structure of claim 3 wherein the receiver identification is stored as a business resource identifier comprising a country code section, an entity code section and a market ID section.

7. The data structure of claim 4 where the date identification includes a year field to denote the year the data structure was generated and a day filed to denote the day of the year the data structure was generated.

8. The data structure of claim 4 wherein the filename further comprises a test/charge indicator that denotes if the data structure is a test file to test a billing system or a charge file that carries billing data.

9. The data structure of claim 4 wherein the filename further comprises a type indicator that denotes if the data structure is an envelope or a message.

10. The data structure of claim 1 wherein the transmission information section further comprises an identification number element that includes a year indicator denoting the year the data structure was generated and a day indicator denoting the day of the year the date structure was generated.

11. The data structure of claim 1 wherein the transmission information section further comprises a return field for indicating the reason an envelope is returned.

12. The data structure of claim 1 wherein the record section further comprises a record heading section that provides information common to all the events in the record section.

13. The data structure of claim 12 wherein the record heading section further comprises a total event attribute for listing the total number of events in the record section.

14. The data structure of claim 12 wherein the record heading section further comprises a reserve field that can be customized by the first party and the second party.

15. The data structure of claim 12 wherein the record heading section further comprises a record return detail element that provides information regarding data structure that are rejected by a validation process.

16. The data structure of claim 1 wherein the record section further comprises an end user section to identify a party who initiated the event or a party for whom the event was initiated.

17. The data structure of claim 1 wherein the record section further comprises one or more event information subsections that provide billing information regarding each event in the record section.

18. The data structure of claim 17 wherein the event information section further comprises an event type attribute to denote the type of service used.

19. The data structure of claim 17 wherein the event information section further comprises a service information subsection.

20. The data structure of claim 19 wherein the service information section further comprises a quality of service element that denotes the quality of services for the event.

21. The data structure of claim 19 wherein the service information section further comprises an administrative element that contains information regarding the event usage.

22. The data structure of claim 19 wherein the rate element is part of a rate detail section.

23. The data structure of claim 22 wherein the rate detail section further comprises a numerator attribute for providing the currency amount per the chargeable unit as stored in the rate element attribute.

24. The data structure of claim 22 wherein the rate detail section further comprises a denominator attribute for providing the chargeable unit as stored in the rate element attribute for a given rate.

25. The data structure of claim 1 further comprising one or more record sections associated with each transmission information section, each record section containing billing information on one or more events.

26. A method for processing billing information between a service provider and a bill processing entity comprising:
generating a data structure at the service provider, the data structure including an identification field and one or more billing records;
sending the data structure to the bill processing entity;
verifying the identification field of the data structure at the bill processing entity;
verifying the format of the data structure at the bill processing entity;
returning the data structure to the service provider if the steps of verifying fails; and
processing the billing records of the data structures that pass the verification steps.

27. The method of claim 26 wherein the step of verifying the format further comprises verifying that the data structure and billing records are properly formatted.

28. The method of claim 27 wherein the step of verifying the identification field further comprises verifying an audit information field for proper values.

29. The method of claim 26 wherein the step of sending the data structure further comprises sending the data structure over an Internet connection.

30. The method of claim 26 wherein the step of sending the data structure further comprises sending the data structure over a direct wired connection.

31. The method of claim 26 wherein the step of sending the data structure further comprises sending the data structure over a wireless connection.

32. The method of claim 26 wherein the step of sending the data structure further comprises sending the data structure on a removable storage medium.

33. The method of claim 26 wherein the step of returning the data structure comprises returning the complete data structure with all billing records if the step of verifying the format fails.

34. The method of claim 26 wherein the step of returning the data structure comprises returning only records that fail the step of verifying the identification field.

35. The method of claim 26 wherein the step of processing the billing records comprises noting incoming billing records as an accounts payable and reconciling the accounts payable against accounts receivables.

36. The method of claim 35 wherein the step of processing the billing record s further comprises reconciling all accounts billable and accounts receivable at the end of a period.

37. A method for processing billing information at a bill processing entity comprising:
receiving a billing data structure including one or more billing records having billing information at the bill processing entity, the billing data structure including a rate element attribute that defines a chargeable unit;
performing a verification process on the billing data structure;
rejecting all or part of the billing data structure if it fails the step of performing a verification process; and
processing the billing data structure at the bill processing entity if the data structure passes the verification steps.

38. The method of claim 37 wherein the step of performing a verification process further comprises verifying that the billing data structure is properly formatted.

39. The method of claim 38 wherein the step of performing a verification process further comprises verifying an audit information field for proper values.

40. The method of claim 37 wherein the step of receiving a billing data structure further comprises receiving the data structure over an Internet connection.

41. The method of claim 37 wherein the step of receiving a billing data structure further comprises receiving the data structure over a direct wired connection.

42. The method of claim 37 wherein the step of receiving a billing data structure further comprises receiving the data structure over a wireless connection.

43. The method of claim 37 wherein the step of receiving a billing data structure further comprises receiving the data structure on a removable storage medium.

44. The method of claim 37 wherein the step of rejecting the billing data structure comprises rejecting the complete data structure if identification information in an identification section are not verified.

45. The method of claim 37 wherein the step of rejecting all or part of the billing data structure comprises rejecting only billing records if the billing records fail a verification process.

46. The method of claim 37 wherein the step of processing the billing records comprises noting incoming billing records as an accounts payable and reconciling the accounts payables against accounts receivables.

47. The method of claim 46 wherein the step of processing the billing records further comprises reconciling all accounts billable and accounts receivable at the end of a period.

48. A system for processing billing information comprising:
a billing computer operable to generate a billing data structure having at least one billing record for at least one billing event, the billing data structure including a rate element attribute that defines a chargeable unit; and
a bill processing computer coupled to the billing computer, the bill processing computer comprising:
a verification engine operable to perform a validation process on the billing data structure;
a return engine operable to process the billing data structure which fail the verification process; and
a process engine coupled to the verification engine to process the billing records that pass the verification process.

49. The system of claim 48 wherein the billing data structure is an original billing envelope comprising one or more billing records.

50. The system of claim 48 wherein the billing data structure is a billing message having one billing record.

51. The system of claim 49 wherein the return engine is further operable to return the entire original billing envelope as a complete return envelope to the provider computer if the original billing envelope fails an identification section validation.

52. The system of claim 49 wherein the return engine is further operable to return a return envelope with all billing records that fail a validation process.

53. The system of claim 50 wherein the return engine is operable to return messages which fail the validation process.

54. The system of claim 50 wherein the billing computer and the bill processing computer are coupled via an Internet connection.

55. The system of claim 50 wherein the billing computer and the bill processing computer are coupled via a direct wired connection.

56. The system of claim 50 wherein the billing computer and the bill processing computer are coupled via wireless connection.

57. The system of claim 50 wherein the billing computer and the bill processing computer are coupled via a manual connection comprising the transfer of a storage medium containing the billing structure.

58. The system of claim 48 wherein the billing data structure further comprising an audit section that includes an account of the total number of records in a data structure and an account of the total charges in the total number of records.

59. The system of claim 48 wherein the billing data structure further comprising an identification field comprising a sender identification, a receiver identification and a data structure identification number.

60. The system of claim 48 wherein the billing data structure further comprises a file name associated with the billing data structure, the file name including the senders identification, a receiver identification and a date identification.

61. The system of claim 59 wherein the sender identification is stored as a business resource identifier comprising a country code section, an entity code section and a market ID section.

62. The system of claim 59 wherein the receiver identification is stored as a business resource identifier comprising a country code section, an entity code section and a market ID section.

63. The system of claim 60 where the date identification includes a year field to denote the year the data structure was generated and a day filed to denote the clay of the year the data structure was generated.

64. The system of claim 60 wherein the filename further comprises a test/charge indicator that denotes if the data structure is a test file to test a billing system or a charge file that carries billing data.

65. The system of claim 60 wherein the filename further comprises a type indicator that denotes if the data structure is an envelope or a message.

66. The system of claim 59 wherein the transmission information section further comprises an identification number element that includes a year indicator denoting the year the data structure was generated and a day indicator denoting the day of the year the date structure was generated.

67. The system of claim 59 wherein the transmission information section further comprises a return field for indicating the reason an envelope is returned.

68. The system of claim 48 wherein the billing data structure further comprises a record heading section that provides information common to all the events in the record section.

69. The system of claim 68 wherein the record heading section further comprises a total event attribute for listing the total number of events in the record section.

70. The system of claim 68 wherein the record heading section further comprises a reserve field that can be customized.

71. The system of claim 68 wherein the record heading section further comprises a record return detail element that provides information regarding data structure that are rejected by the verification engine.

72. The system of claim 48 wherein the billing data structure further comprises an end user section to identify a party who initiates the event or a party for whom the event was initiated.

73. The system of claim 48 wherein the billing data structure further comprises one or more event information subsections that provide billing information regarding each event in the record section.

74. The system of claim 73 wherein the event information section further comprises an event type attribute to denote the type of service used.

75. The system of claim 73 wherein the event information section further comprises a service information subsection.

76. The system of claim 75 wherein the service information section further comprises a quality of service element denotes the quality of services for the event.

77. The system of claim 75 wherein the service information section further comprises an administrative element that contains information regarding the event usage.

78. The system of claim 75 wherein the rate element is part of a rate detail section.

79. The system of claim 78 wherein the rate detail element further comprises a numerator attribute for providing the currency amount per the chargeable unit as stored in the rate element attribute.

80. The system of claim 78 wherein the rate detail element further comprises a denominator attribute for providing the chargeable units as stored in the rate element attribute for a given rate.

81. The system of claim 48 wherein the billing data structure further comprising an identification field associated with one or more billing records.

82. A settlement method between a first provider and a second provider the method comprising:
generating one or more first provider billing data structure at the first provider based on services provided for the second provider, the billing data structure including a rate element attribute that defines a chargeable unit;
storing an account of the total charges and total taxes from the one or more first providers data structures as an accounts receivable for the first provider;
sending the one or more billing data structures to the second provider;
receiving one or more second provider billing data structures based on services provided for the first provider;
validating the one or more second provider billing data structures;
storing an account of the total charges and total taxes from the one or more second providers data structure as an accounts payable; and
reconciling the accounts payables and accounts receivables at the end of a period.

83. The method of claim 82 further comprising generating invoices or reports regarding the accounts payables and accounts receivable.

84. The method of claim 82 further comprising settling the accounts payable and receivable.

85. The method of claim 82 wherein the step of validating further comprising performing an audit check using an audit field of the billing data structure.

86. The method of claim 82 wherein the step of generating a billing data structure further comprises generating an envelope containing one or more billing records.

87. The method of claim 82 wherein the step of generating a billing data structure further comprises generating a message containing one billing record.

88. A program product comprising:
a computer readable medium having computer readable code means embodied therein for storing a billing data structure, the billing data structure comprising;
computer readable code means for storing an identification information;
computer readable code means for storing billing information in one or more records containing one or more billing events, the billing information including a rate element attribute for defining the unit of a rate the service is to be charged.

89. The product of claim 88 further comprising computer readable code for storing an audit section that includes an account of the total number of records in a data structure and an account of the total charges in the total number of records.

90. The product of claim 88 wherein the identification information includes a sender identification, a receiver identification and a data structure identification number.

91. The product of claim 88 further comprising computer readable code for storing a file name associated with the billing data structure, the file name including the senders identification, a receiver identification and a date identification.

92. The product of claim 90 wherein the sender identification is stored as a business resource identifier comprising a country code section, an entity code section and a market ID section.

93. The product of claim 90 wherein the receiver identification is stored as a business resource identifier comprising a country code section, an entity code section and a market ID section.

94. The product of claim 91 where the date identification includes a year field to denote the year the data structure was generated and a day filed to denote the day of the year the data structure was generated.

95. The product of claim 91 wherein the filename further comprises a test/charge indicator that denotes if the data structure is a test file to test a billing system or a charge file that carries billing data.

96. The product of claim 91, wherein the filename further comprises a type indicator that denotes if the billing data structure is an envelope or a message.

97. The product of claim 88, wherein the identification information further comprises an identification number element that includes a year indicator denoting the year the data structure was generated and a day indicator denoting the day of the year the date structure was generated.

98. The product of claim 88, wherein the identification information further comprises a return field for indicating the reason an envelope is returned.

99. The product of claim 88, wherein the record further comprises a record heading section that provides information common to all the events in the record section.

100. The product of claim 99, wherein the record heading section further comprises a total event attribute for listing the total number of events in the record section.

101. The product of claim 99, wherein the record heading section further comprises a reserve field that can be customized.

102. The product of claim 99, wherein the record heading section further comprises a record return detail element that provides information regarding data structure that rejected by a validation engine.

103. The product of claim 88, wherein the record further comprises an end user section to identify a party who initiates an event or a party for whom the event was initiated.

104. The product of claim 88, wherein the record further comprises one or more event information subsections that provide billing information regarding each event in the record section.

105. The product of claim 104, wherein the event information section further comprises an event type attribute to denote the type of service used.

106. The product of claim 104, wherein the event information section further comprises a service information subsection.

107. The product of claim 106, wherein the service information section further comprises a quality of service element that denotes the quality of services for the event.

108. The product of claim 106, wherein the service information section further comprises an administrative element that contains information regarding the event usage.

109. The product of claim 106, wherein the rate element is part of a rate detail section.

110. The product of claim 109, wherein the rate detail section further comprises a numerator attribute for providing the currency amount per the chargeable unit stored in the rate element attribute.

111. The product of claim 109, wherein the rate detail section further comprises a denominator attribute for providing the chargeable units as stored in the rate element attribute for a given rate.

112. A system for processing billing information comprising:
a first entity computer operable to generate a billing data structure having billing records comprising one or more billing events, each of the one or more billing events defined by a rate element attribute that denotes a chargeable unit;
a second entity computer coupled to the first entity computer, the second entity computer operable to access the billing information in the record and account for new charges as an accounts payable.

113. The method of claim 112 further comprising generating invoices or reports regarding the accounts payables and accounts receivable.

114. The method of claim 113 further comprising settling the accounts payable or receivable.

115. The method of claim 112 wherein the step of Validating further comprising performing an audit check using an audit field of the billing data structure.

116. The method of claim 112 wherein the step of generating a billing data structure further comprises generating an envelope containing one or more billing records.

117. The method of claim 112 wherein the step of generating a billing data structure further comprises generating a message containing one billing record.
